(19) United States
(12) Patent Application Publication
(10) Pub. No.: US 2017/0152107 A1
(43) Pub. Date: Jun. 1, 2017

(54) BATTERY LIFTER

(71) Applicant: F&G Accessories, LLC, Commerce Twp., MI (US)

(72) Inventor: John Gilgallon, Commerce Twp., MI (US)

(73) Assignee: F&G Accessories, LLC, Commerce Twp., MI (US)

(21) Appl. No.: 15/293,739

(22) Filed: Oct. 14, 2016

Related U.S. Application Data
(60) Provisional application No. 62/241,202, filed on Oct. 14, 2015.

(51) Int. Cl. B65G 7/12; H01M 2/10

(52) U.S. Cl. CPC B65G 7/12; H01M 2/1005

(57) ABSTRACT

The present invention provides, in a first embodiment, a battery lifter including: at least one arm having a first end and a second end; at least one leg extending from an end of the at least one arm; and opposed means for grasping a battery, each means for grasping including a hook formed at an end of the at least one leg opposite that of the at least one arm, and an inwardly directed toe disposed on the end of the hook opposite the at least one leg for engaging the battery. In an alternative arrangement, the present invention provides a battery lifter including: a first element and a second element, the first and second elements each including a plate, an extension extending laterally from an end of the plate, and a downwardly depending leg extending from an end of the extension opposite the plate; the leg of each of the elements including a hook for engaging battery; and means for adjusting the position of the second element relative to the first element.

### CROSS-REFERENCE TO RELATED APPLICATION

This application is a completion application and which claims the priority benefit of co-pending U.S. Provisional Patent Application Ser. No. 62/241,202, filed Oct. 14, 2015, for “Battery Lifter,” the entire disclosure of which is hereby incorporated by reference in its entirety, including the drawing.

### BACKGROUND OF THE INVENTION

1. Field of the Invention

The present invention pertains to vehicular batteries. More particularly, the present invention pertains to means for facilitating the removal of vehicular batteries. Even more particularly, the present invention pertains to devices for removing vehicular batteries which are positioned in a confined area.

2. Prior Art

As is known to those skilled in the art to which the present invention pertains, smaller vehicles, such as motorcycles, golf carts, mopeds, and similar such vehicles have small batteries which are disposed in rather confined spaces. Although these batteries are relatively small, they still have considerable weight associated therewith. Thus, when the need for removal of the battery becomes necessary, it is difficult to manipulate and position one's hand(s) to facilitate the removal.

The prior art has taught many devices such as tongs, calipers, etc. for lifting bricks, batteries, etc. See, inter alia, U.S. Pat. Nos. 1,153,269; 1,581,077; 1,586,475; 835,376; 1,091,260; 1,364,128; 3,129,029; 5,039,150; 7,234,742; 282,134; 4,527,823; and 4,055,364. Each of these devices enables the lifting of bricks, batteries, etc. However, in some instances many of these prior art devices are difficult to maneuver, do not exhibit the requisite strength to hold a battery, and, in other instances, simply are not capable of sufficiently engaging a battery for easy lifting.

The present invention, as detailed below, provides an adjustable lifter that overcomes the deficiencies in the prior art.

It is to this to which the present invention is directed.

The above references are identified herein in recognition of a duty of disclosure of known related subject matter, which may be relevant under 37 CFR 1.56, and specifically incorporated, herein by reference as regards to the conventional approaches and constructions taught therein.

### SUMMARY OF THE INVENTION

The present invention provides a battery lifter comprising: (a) at least one arm having a first end and a second end; (b) at least one leg extending from an end of the at least one arm; and (c) opposed means for grasping a battery, each means for grasping including a hook formed at an end of the at least one leg opposite that of the at least one arm, the hook being downwardly depending from and integrally formed with the at least one leg, and an inwardly directed toe disposed on the end of the hook opposite the at least one leg for engaging the battery.

In a first embodiment, the battery lifter comprises a first arm and a second arm rotatably secured to one another. Each arm includes means for grasping such that upward movement and contemporaneous rotation of the first arm compresses or moves each means for grasping toward one another. In use, each means for grasping extends downwardly on opposite sides of the battery. The first arm is lifted in order to cause each means for grasping to engage the battery to facilitate lifting thereof. Furthermore, the battery lifter includes means for positioning the second arm relative to the first arm.

In a second embodiment, the battery lifter includes means for biasing for creating tension between each means for grasping.

In a third embodiment, the leg extending from the at least one arm is torqued or formed normal to the at least one arm.

In a fourth embodiment, the battery lifter includes means for positioning a second arm relative to a first arm, comprising a slot is formed in the first arm to allow the second arm to be slidably inserted therein. The second arm includes a plurality of spaced apart gaps or seats that allow the second arm to be seatably positionable within the slot formed in the first arm, thereby adjusting the position of the second arm relative to the first arm.

A fifth embodiment of the battery lifter comprises an arm having a first end and a second end. Each end of the arm includes means for grasping. Here, the battery lifter is manufactured from a spring steel as an integral, unitary member in order to provide sufficient flexibility when the means for grasping engages and facilitates lifting of the battery.

In a sixth embodiment, the battery lifter comprises: (a) a first element and a second element, the first and second elements each including a plate, an extension extending laterally from an end of the plate, and a downwardly depending leg extending from an end of the extension opposite the plate forming a shoulder therebetween; (b) the leg of each of the elements including a hook formed on the terminus thereof for engaging a battery, the hook being disposed at an end of the leg opposite the extension; and (c) means for adjusting the position of the second element relative to the first element.

In accordance with the sixth embodiment, the battery lifter further comprises an opening formed in the plate of the first element and a scalloped track having a plurality of arcs formed in the plate of the second element. The means for adjusting the position of the second element relative to the first element being a threaded fastener positionable within each of the plurality of arcs for providing incremental sliding adjustment of the second element relative to the first element.

For a better understanding of the present invention, reference is made to the accompanying drawing and detailed description. In the drawing, like reference numerals refer to like parts through the several views, in which:

### BRIEF DESCRIPTION OF THE DRAWING

FIG. 1 is a perspective view of a lifter in accordance with the present invention in use;

FIG. 2 is a first side view of the lifter hereof, as assembled;

FIG. 3 is a second side view of the lifter hereof, as seen from the side opposite of that of FIG. 2;

FIG. 4 is an exploded view of the arms of the lifter hereof;

FIG. 5 is a side view of a second embodiment of the lifter in accordance with the present invention;

FIG. 6 is an end view of the second embodiment hereof;

FIG. 7 is a side view of a third embodiment hereof;

FIG. 8 is a side view of a fourth embodiment hereof;

FIG. 9 is a end view of the fourth embodiment hereof;

FIG. 10 is a side view of a fifth embodiment hereof;

FIG. 11 is a side view of a sixth embodiment of the lifter in accordance with the present invention showing a first position for a handle of the lifter;

FIG. 12 is a side view similar to FIG. 11, but showing the handle in a second position;

FIG. 13 is a top view of the lifter of FIG. 11;

FIG. 14 is a side view of the lifter in accordance with the embodiment of FIG. 11 in a loosened position; and

FIG. 15 is a side view of the lifter in accordance with the embodiment of FIG. 11 in use with a battery.

### DETAILED DESCRIPTION OF THE INVENTION

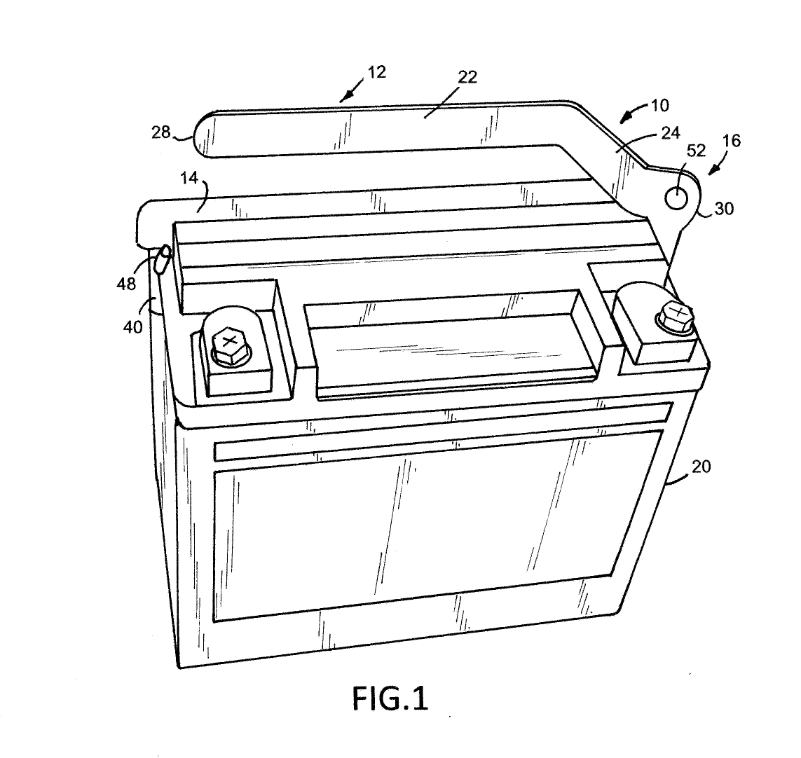

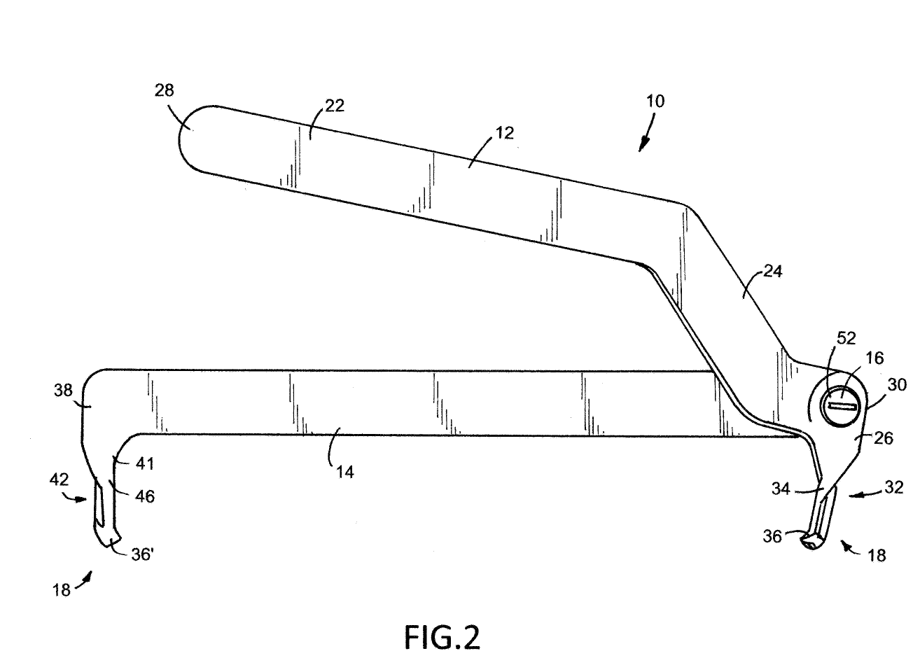

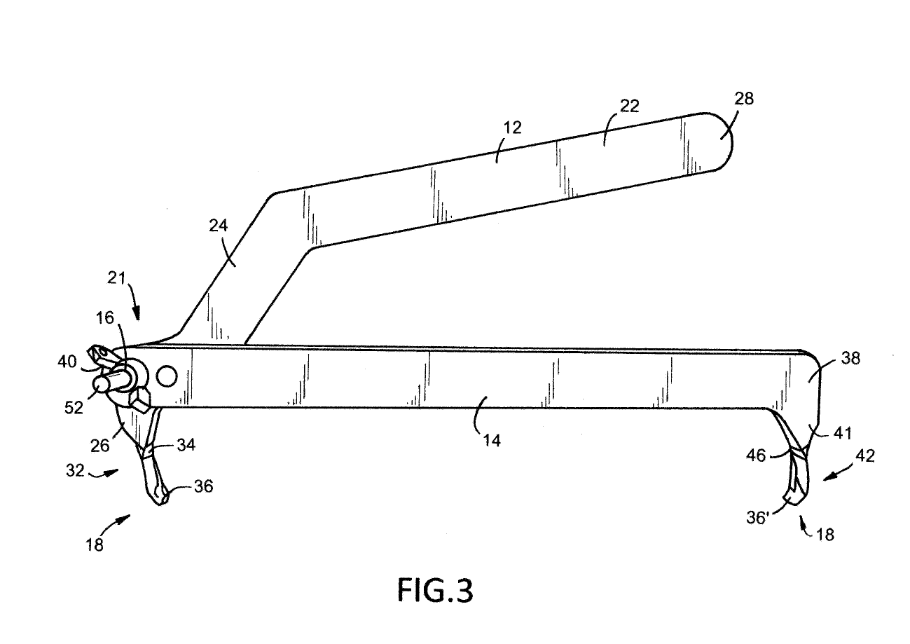

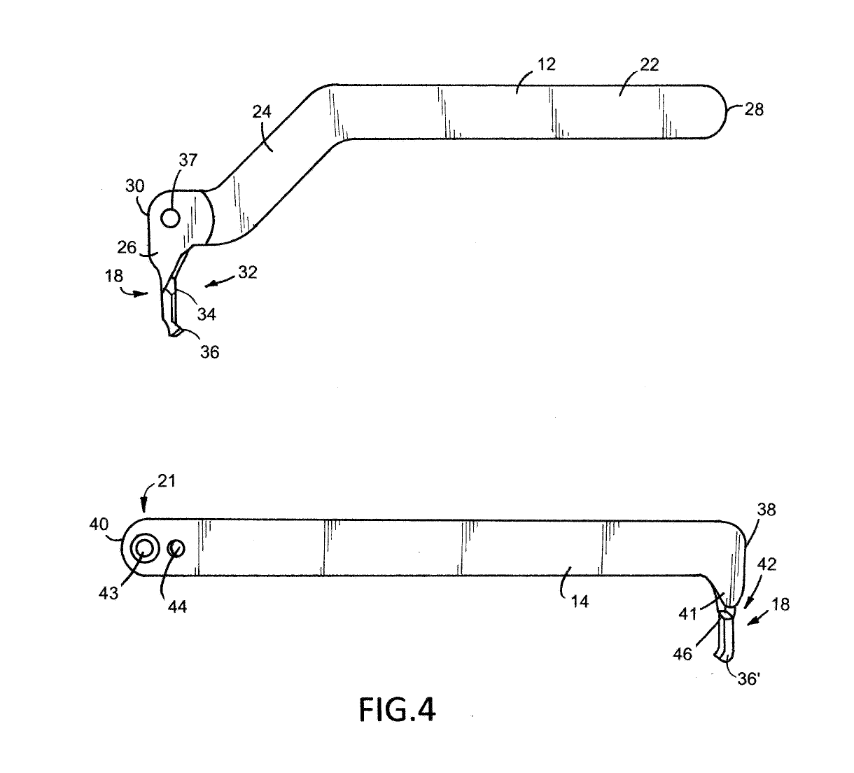

Now, in accordance with a first embodiment of the present invention and with reference to FIGS. 1-4 of the drawing, there is provided a battery lifter or caliper, generally, denoted as 10. The lifter 10 comprises: (a) a first arm 12; (b) a second arm 14; and (c) means 16 for pivoting the first arm 12 relative to the second arm 14.

Each arm 12, 14 includes means 18 for grasping an end of a battery 20 and means 21 for adjusting the position of the second arm 14 with respect to the first arm 12.

More particularly, and as shown, the first arm 12 comprises a first leg 22, a second leg 24, and a third leg 26 angularly inclined with respect to the second leg 24. The first arm 12 has a first end 28 and a second end 30. A hook 32 downwardly depends from and is integrally formed with the third leg 26. The hook 32 has a helically wound portion or turn 34 and an angularly disposed tip or toe 36 for engaging the side of the battery 20.

An aperture 37 is formed at the second end 30 of the first arm 12. The aperture 37 is used for mounting the means 16 to the two arms 12, 14.

The second arm 14 has a first end 38 a second end 40 and an integrally formed depending leg 41. The second end 40 includes a depending hook 42, which is a mirror image of the hook 32 of the first arm 12, including a helically wound portion or turn 46 and an angularly disposed tip or toe 36′ for engaging the side of the battery 20.

The second arm 14 includes the means 21 for adjusting the position of the second arm 14 with respect to the first arm 12.

The means 21 comprises a pair of spaced apart co-axial apertures 43, 44. Each of the apertures 43, 44 are dimensioned to be in registry with the aperture 37 on the first arm 12.

As detailed subsequently, the apertures 37, 43, 44 are used in conjunction with the means for pivoting or rotating or pivot member 16.

The means for pivoting or rotating 16 interconnects the first and second legs 12, 14.

The means for pivoting or rotating 16 includes a fastener such as a screw and nut or screw and wing nut assembly 52, which projects through the aperture 37 of the first leg 12 and into one of the selected apertures 43, 44 of the second leg 14 in order to enable the first leg 12 to rotate thereabout and, thus, rotate with respect to the second leg 14.

As shown, the second arm 14 has a length substantially equal to the length of the battery 20. The first arm 12 is positioned relative to the second arm 14 such that the toe 36 of the first arm 12 engages one side of the battery 20 and the toe 36′ of the second arm 14 engages the opposite side of the battery 20.

In use, and as shown, the first and second arms 12, 14 are substantially parallel to each other while their respective hooks 32, 42 or toes 36, 36′ engage, preferably, the lid of a battery 20. Once the hooks 32, 42 or toes 36, 36′ of the first and second arms 12, 14, respectively, engage the battery 20, the user merely inserts his or her fingers in the spaces between the arms 12, 14 and upwardly lifts the battery 20 out of its stowed position.

The lifter 10 can then be disengaged from the battery 20 by rotating the arms 12, 14 relative to one another to lengthen the overall length of the lifter 10.

Similarly, the distance between the hooks 32, 42 of the first and second arms 12, 14, respectively, that engage the lid can be adjusted by upwardly rotating the first arm 12 relative to the second arm 14. This rotation causes the hook 32 of the first arm 12 to move closer to the opposing hook 42 on the second arm 14.

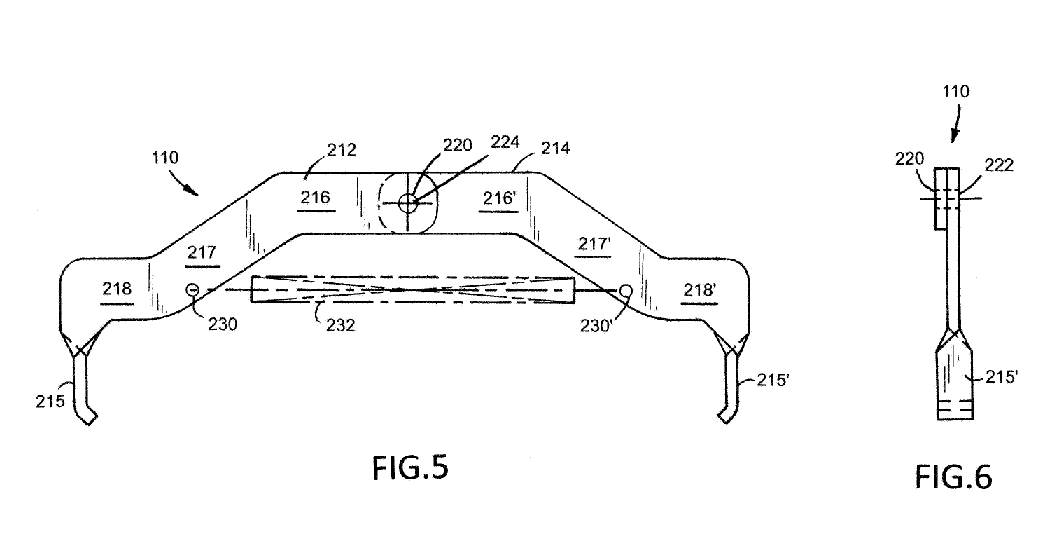

Referring now to FIGS. 5 and 6, there is depicted therein a second embodiment of the lifter in accordance with the present invention, generally, denoted at 110.

As shown in the drawing, a pair of congruent legs or plates 212, 214 are disposed in opposite directions.

Each leg 212, 214 has a downwardly depending means for grasping 215, 215′ analogous to the means element 18. The means for grasping 215, 215′ being in opposition to one another.

Each leg or plate 212, 214 is constructed analogously to the arms 12, 14 of the first embodiment but only shorter in length.

As shown, each leg 212, 214 comprises a first section 216, 216′, a second section 217, 217′ and a third section 218, 218′, respectively. The respective means for grasping 215, 215′ downwardly depends from their respective third sections 218, 218′.

Each leg 212, 214 has an aperture or opening 220, 222, respectively, which are each positioned or disposed in a manner to be coincident when in an overlapping position.

A pivot 224, such as a screw, bolt, or rod projects through the coincident openings 220, 222 and are secured thereto.

The pivot 224 enables each of the legs 212, 214 to be grasped at their respective first sections 216, 216′ and to be lifted upwardly. As the legs 212, 214 are lifted upwardly, the opposed means for grasping 215, 215′ engage a battery to facilitate lifting thereof.

Alternatively, and as shown in the drawing, the second section 217, 217′ of the first and second legs 212, 214, respectively, is provided with an aperture 230, 230′. Means for biasing such as a spring 232 is secured at each of its ends to its associated apertures 230, 230′.

The means for biasing 232 allows the lifter 110 to remain attached to the battery when no upward pressure is applied. It is the inherent structure of the battery which causes the clamping pressure to increase without lifting.

To remove the battery, the user grasps the first sections 216, 216′ of each leg 212, 214 and then pulls upwardly causing the means for grasping 215, 215′ to operate against the force of the spring 232 and to facilitate removal of the battery therefrom.

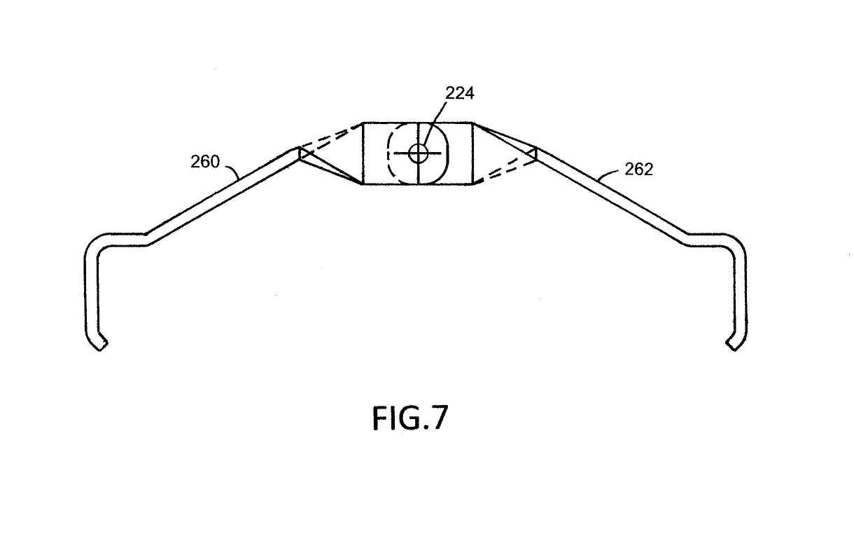

Alternatively, and as shown in FIG. 7, a third embodiment of the present invention includes a pair of legs 260, 262 that are torqued or formed normal to the plane of the legs 212, 214, such that they extend planar to the pivot 224.

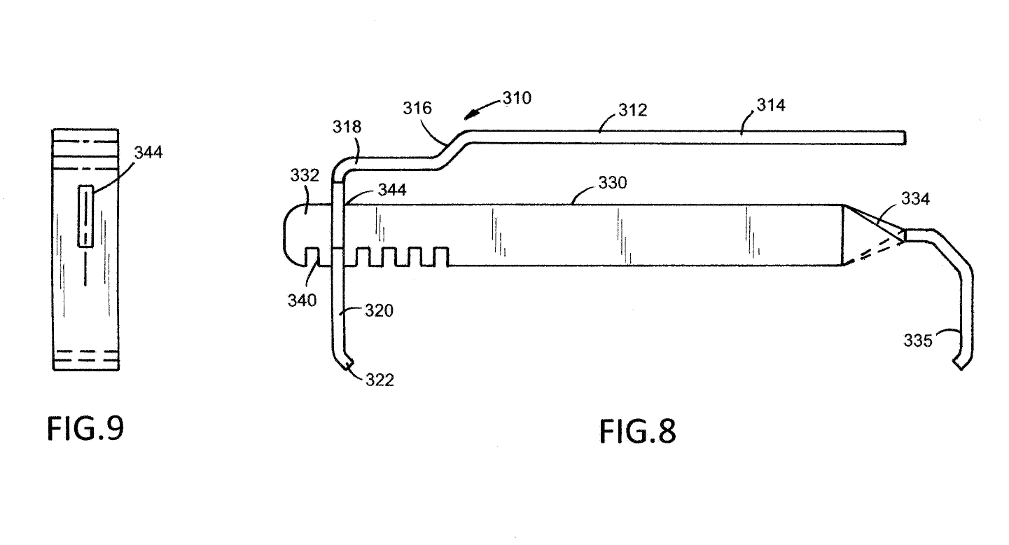

Referring now to FIGS. 8 and 9, there is depicted a fourth embodiment of the lifter in accordance with the present invention, generally, denoted at 310.

According to this embodiment, an arm 312 comprises an elongated element 314 having a step or inclined element 316 and an extension element 318. A first leg 320 downwardly depends from the extension element 318 and is disposed substantially normal to the elongated element 314.

Means for grasping 322, analogous to means for grasping 18 in the first embodiment, is formed at the terminus of first leg 320.

This embodiment further includes a second leg 330 comprising a substantially planar member having a first end 332 and an opposed second end 334.

The second end 334 includes means for grasping 335 in opposition to the means for grasping 322 in the first leg 320.

As shown in the drawing, the second leg 330 has a plurality of gaps 340 equidistantly spaced along the bottom of the second leg 330.

A slot 344 is formed in leg 320. The slot 344 is dimensioned to enable the second leg 330 to project therethrough and to seat the second leg 330 within the first leg 320 by positioning one of the plurality of gaps 340 within the slot 344. In this manner, the lifter 310 can be adjusted in length to accommodate various size batteries.

As with the first embodiment, the battery is lifted by grasping the arm 312 and lifting the battery lifter 310 upwardly which causes the means for grasping 322 to bias inwardly toward the battery.

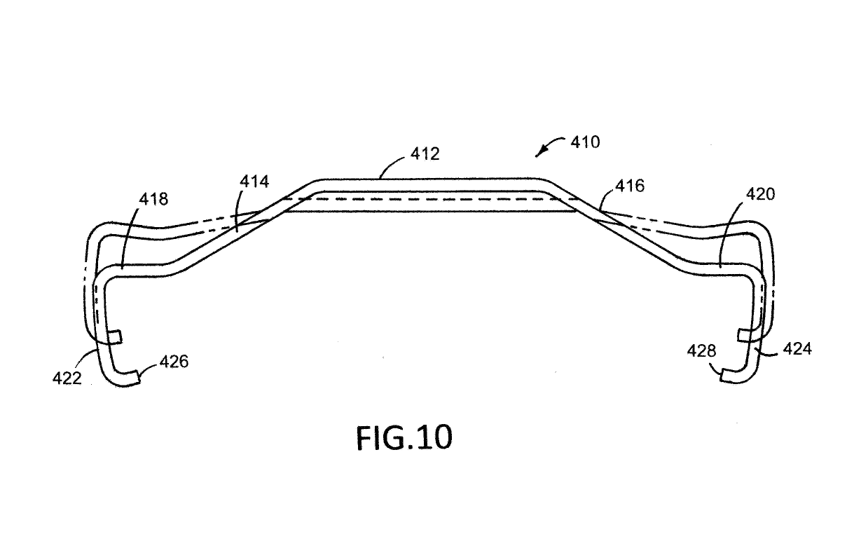

In FIG. 10, there is depicted a fifth embodiment of the lifter hereof. According to this embodiment, the lifter, which is generally denoted at 410, is manufactured from a spring steel as an integral, unitary member.

The lifter 410 comprises a first section or handle 412 and opposed laterally outwardly extending and downwardly depending legs 414, 416, respectively.

Each leg 414, 416 has an integrally formed third leg 418, 420, respectively.

Each third leg 418, 420 includes a downwardly depending hook element 422, 424, respectively. Each hook element 422, 424 has an inwardly directed toe 426, 428, respectively.

According to this embodiment, in use, the handle 412 is upwardly directed, as shown in phantom, from a first position to a second position. Because of the spring steel material, the handle 412 flexes around a top of a battery. The toes 426, 428 then engage a lip of the top.

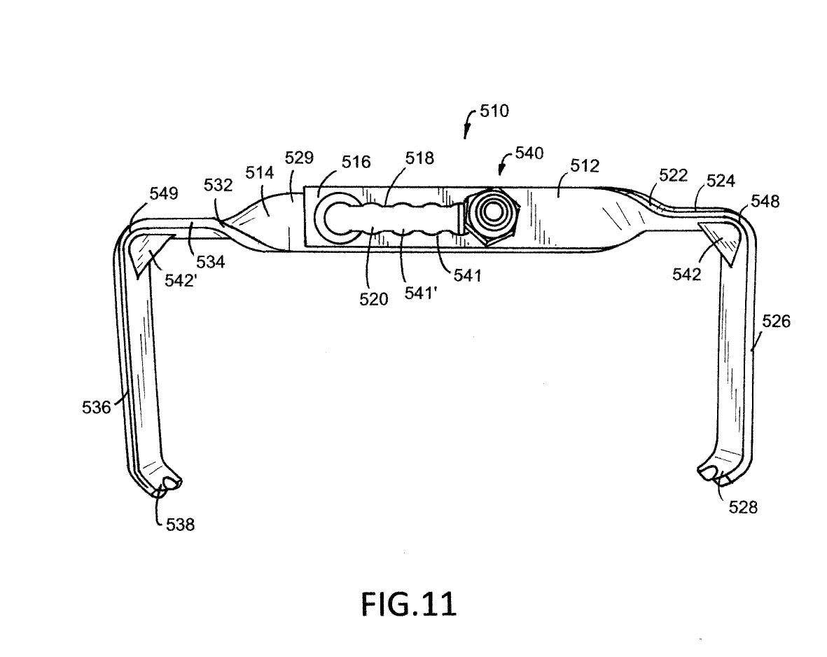

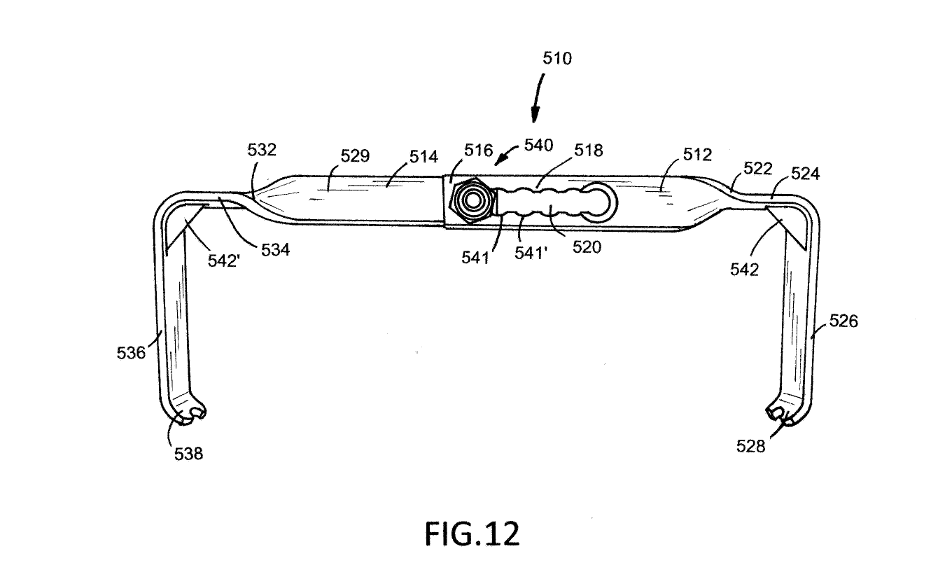

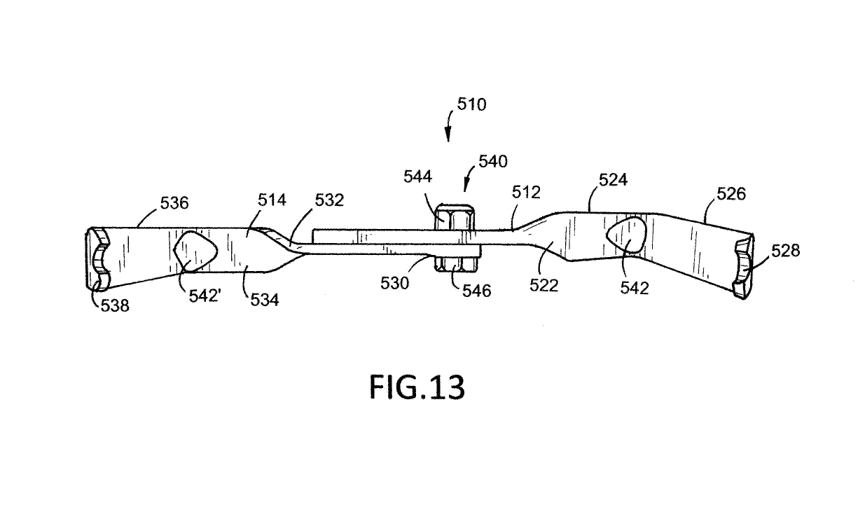

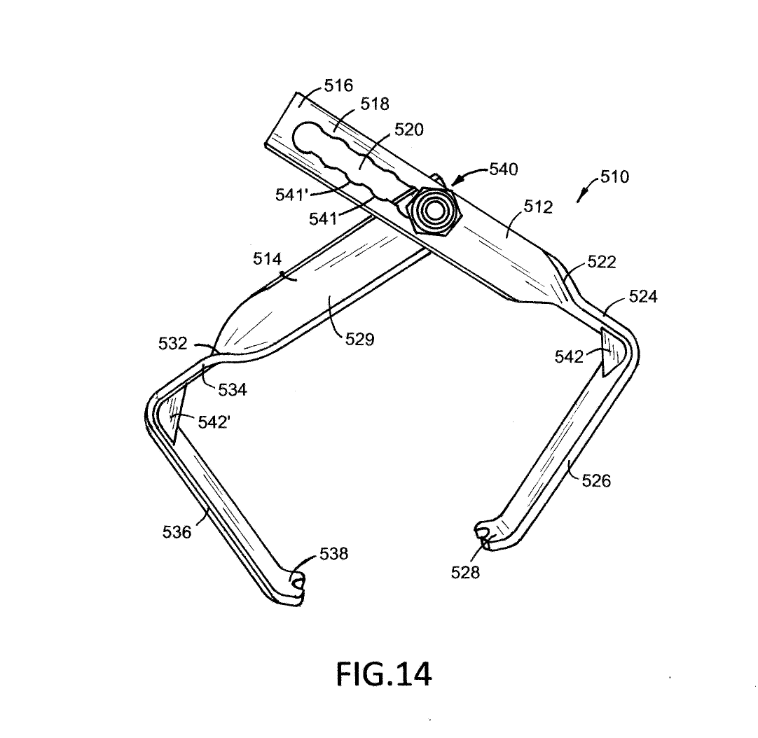

Referring now to FIGS. 11-14 there is shown therein a sixth embodiment of the lifter of the present invention and, generally, denoted at 510.

According to this embodiment, the length of the lifter 510 is adjustable incrementally along its latitudinal axis.

More particularly, the lifter 510 hereof comprises a first element 512 and a second mating element 514. The first element 512 comprises a plate 516 that has a scalloped track 518 which defines a plurality of arcs 541, 541′, etc. A central opening 520 is formed within the track 518. The track 518 enables the incremental sliding adjustment of the lifter 510 by enabling positioning means for adjusting 540 between opposed arcs 541, 541′ of the track 518.

The first element 512 further includes a torqued twist 522 which defines an extension 524 of the plate 516.

A leg 526 downwardly depends from the extension 524 at a shoulder 548, as shown. The shoulder 548 includes an indentation or rib 542 formed therein and protrudes inwardly. The rib 542 improves upon the structural strength of the lifter 510 when in use by providing increased tension between the extension 524 and the leg 526. The leg 526 terminates at a toe or hook 528, as shown.

The second element 514 comprises a substantially planar member or plate 529 having an opening 530 formed therein.

The second element 514 further includes a twist 532 and an extension 534. A downwardly depending leg 536 extends laterally downwardly from the extension 534 at a shoulder 549 in opposition to the leg 526 of the first element 512. The shoulder 549 includes an indentation or rib 542′ formed therein and protrudes inwardly similar to the rib 542 on the first element 512. A hook or toe 538 is provided at the lower terminus of the leg 536 and, in operation, is in opposition to the toe or hook 528 of the first element 512.

Means for adjusting the position 540 generally comprises a threaded fastener 542 which projects through the opening 530 and into any one of the selected scalloped opposed arcs in the track 520. Fastening means such as at least one nut 544 secures the fastener in position.

In use, the two elements 512, 514 are loosely secured together via the fastener 544 and at least one nut 546 in loose arrangement.

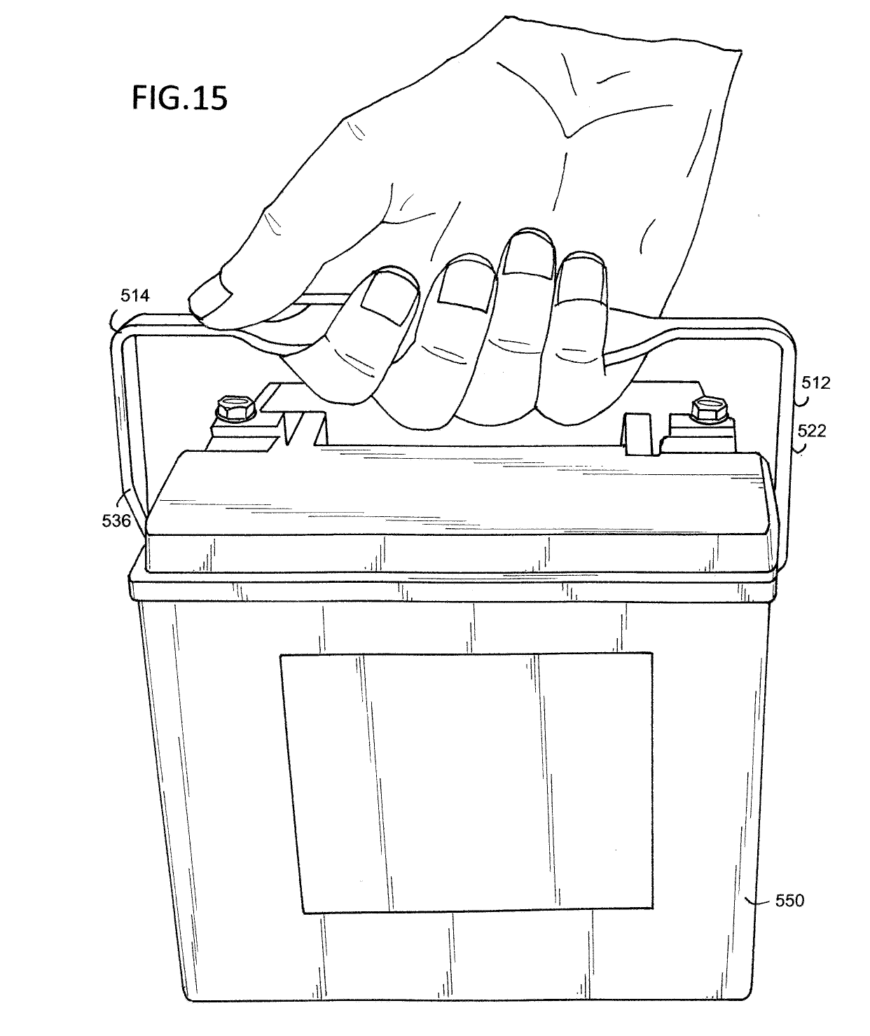

As shown in FIG. 15, the first and second elements 512, 514 are then adjusted in position according to the width of the battery 550. Once the requisite length of the lifter 510 is achieved the elements 512, 514 are then locked together by tightening the nut or bolt(s) 546.

The legs 522, 536 are then positioned along the sides of the battery 550 and an upward lifting force is applied. The hooks or toes 528, 538, respectively, then engage the upper edge of the battery 550 to facilitate lifting thereof.

From the above it is readily appreciated that the present invention provides a lifter or caliper which facilitates the removal of a small battery for smaller vehicles.

Having thus described the invention, what is claimed is:

### LIST OF REFERENCE NUMBERS

10 Lifter
12 First arm
14 Second arm
16 Means for pivoting the first and second arm
18 Means for grasping an end of a battery on each arm
20 Battery
21 Means for adjusting position of the second arm
22 First leg of first arm
24 Second leg of first arm
26 Third leg of first arm
28 First end of first arm
30 Second end of first arm
32 Hook of first arm
34 Turn of first arm
36 Toe of first arm
36′ Toe of second arm
37 Aperture
38 First end of second arm
40 Second end of second arm
41 Depending leg of second arm
42 Hook of second arm
43 Aperture
44 Aperture
46 Turn of second arm
52 Screw and nut assembly
110 Second embodiment of lifter
212 First leg
214 Second leg
215 Downwardly depending means for grasping of first leg
215′ Downwardly depending means for grasping of second leg
216 First section of first leg
216′ First section of second leg
217 Second section of first leg
217′ Second section of second leg
218 Third section of first leg
218′ Third section of second leg
220 Opening of first leg
222 Opening of second leg
224 Pivot
230 Aperture of first leg
230′ Aperture of second leg
232 Means for biasing
260 First plate
262 Second plate
310 Fourth embodiment of the lifter
312 Arm
314 Elongated element
316 Step
318 Extension element
320 First leg
322 Means for grasping of first arm
330 Second leg
332 First end of second arm
334 Second end of second arm
335 Means for grasping of second arm
340 Gaps
344 Slot
410 Fifth embodiment of the lifter
412 Handle
414 First leg
416 Second leg
418 Third leg
420 Third leg
422 Hook element
424 Hook element
426 Toe
428 Toe
440 Top of battery
450 Lip of top of battery
510 Sixth embodiment of lifter
512 First element
514 Second element
516 Plate of first element
518 Scalloped track of plate
520 Central opening of scalloped track
522 Twist of first element
524 Extension of first leg
526 Leg of first element
528 Hook of first element
529 Planar member of second element
530 Opening formed in second element
532 Twist of second element
534 Extension of second element
536 Leg of second element
538 Hook of second element
540 Means for adjusting
541 Arc
541′ Arc
542 Rib of first element
542′ Rib of second element
544 Threaded fastener
546 Nut
548 Shoulder of first element
549 Shoulder of second element
550 Battery

1. A battery lifter comprising:
(a) at least one arm having a first end and a second end;
(b) at least one leg extending from an end of the at least one arm; and
(c) opposed means for grasping a battery, each means for grasping including a hook formed at an end of the at least one leg opposite that of the at least one arm, the hook being downwardly depending from and integrally formed with the at least one leg, and an inwardly directed toe disposed on the end of the hook opposite the at least one leg for engaging the battery.

2. The battery lifter of claim 1 wherein the hook includes a twist formed therein.

3. The battery lifter of claim 1 further comprising a pair of legs, each one of the pair of legs extending from an associated one of the first end and the second end of the at least one arm.

4. The battery lifter of claim 3 wherein each means for grasping extends from an associated one of the pair of legs opposite the at least one arm.

5. The battery lifter of claim 1 further comprising:
(a) a first arm and a second arm, the first arm and the second arm each having a first end and a second end;
(b) means for adjusting the position of the second arm relative to the first arm; and
wherein one of the means for grasping extends from an end of the leg of the first arm and the other of the means for grasping extends from an end of the leg of the second arm.

6. The battery lifter of claim 5 further comprising means for pivoting the first arm and the second arm.

7. The battery lifter of claim 5 wherein the means for adjusting the position of the second arm is a spring interconnecting the leg of each of the first arm and the second arm.

8. The battery lifter of claim 5 further comprising:
(a) a slot formed in the leg of the first arm for allowing the second arm to be slidably insertable therethrough; and
(b) the means for adjusting the position of the second arm cooperating with the slot in the first arm, the means for adjusting including a plurality of spaced apart gaps formed in the bottom of the first end of the second arm, each one of the plurality of gaps dimensioned to be seatable within the slot in the leg of the first arm.

9. The battery lifter of claim 6 further comprising:
(a) an aperture formed proximate the second end of the first arm;
(b) the means for adjusting the position of the second arm cooperating with the aperture in the first arm, the means for adjusting including at least a pair of apertures formed proximate the second end of the second arm; and
wherein the means for pivoting the first arm and the second arm secures the aperture of the first arm to one of the pair of apertures of the second arm in order to adjust the position of the second arm relative to the first arm.

10. The battery lifter of claim 9 wherein the means for pivoting is a threaded fastener and a nut assembly.

11. A battery lifter comprising:
(a) a first element and a second element, the first and second elements each including a plate, an extension extending laterally from an end of the plate, and a downwardly depending leg extending from an end of the extension opposite the plate forming a shoulder therebetween;
(b) the leg of each of the elements including a hook formed on the terminus thereof for engaging a battery, the hook being disposed at an end of the leg opposite the extension; and
(c) means for adjusting the position of the second element relative to the first element.

12. The battery lifter of claim 11 further comprising a twist formed in each of the extensions, the extensions being formed normal to an associated plate.

13. The battery lifter of claim 11 further comprising a first opening formed in the first element and a second opening formed in the second element, the means for adjusting the position of the second element extending through the first and second openings.

14. The battery lifter of claim 13 wherein the means for adjusting the position of the second element includes a threaded fastener and a nut assembly.

15. The battery lifter of claim 14 wherein the second opening in the second element is a scalloped track having a plurality of arcs, the threaded fastener being positionable within each of the plurality of arcs for providing incremental sliding adjustment of the second element relative to the first element.

16. The battery lifter of claim 11 further including an inwardly protruding rib formed in the shoulder of each of the first and second elements.
